(19) United States
(12) Patent Application Publication
(10) Pub. No.: US 2007/0259234 A1
(43) Pub. Date: Nov. 8, 2007

(54) Metal-air semi-fuel cell with an aqueous acid based cathode

(76) Inventors: David Chua, Wayne, PA (US); Mark Salomon, Little Silver, NJ (US); Ian Kowalczyk, Harleysville, PA (US)

Correspondence Address: DAVID CHUA, 845 Babb Circle, WAYNE, PA, 19087, US

(21) Appl. No.: 11/418,629

(22) Filed: May 6, 2006

(51) Int. Cl. H01M 12/06; H01M 2/16

(52) U.S. Cl. 429/27; 429/247; 429/29; 429/144

(57) ABSTRACT

A metal-air semi-fuel cell is provided, preferably based on lithium anode and a fuel cell type air/oxygen electrode immersed in an aqueous neutral, alkali or acid solution. The lithium anode is comprised of the active metal and one or more separators protecting the anode from reacting with an aqueous solution. The outermost layer on the lithium electrode is a solid-state lithium-ion conducting glass-ceramic which is impervious to and stable towards aqueous solutions. The cathode is comprised of an air or oxygen fuel cell type electrode in contact with the aqueous solution. The lithium anode of this invention also can be replaced by other electroactive metals which react with water and acids, bases and neutral solutions, such as metals from Groups 1 and 2 of the Periodic Table of Elements in addition to Zn, Mg, and Al.

### CROSS REFERENCE TO RELATED DOCUMENTS

The subject matter of the invention is shown and described in the Disclosure Document of David Chua Ser. No. 596,219 filed on Mar. 9, 2006 and entitled “Lithium-Air Semi-Fuel Cell with an Aqueous Acid Based Cathode.”

### BACKGROUND OF THE INVENTION

1. Field of the Invention

This invention pertains mostly to a lithium-air semi-fuel cell which is comprised of a metallic lithium anode with suitable protection to prevent direct contact with aqueous solutions, and a cathode based on a fuel cell type air/oxygen electrode which contacts an aqueous acid, base, or neutral solution. Other metal anodes are also useable in this cell structure.

2. Description of the Prior Art

Hydrogen-oxygen fuel cells are highly efficient, low voltage systems which require storage of hydrogen and oxygen in heavy pressurized containers to achieve high capacity batteries (Fuel Cell Handbook), Linden et al. (Handbook of Batteries) reviewed the advantages of hydrogen and metal air batteries such Zn-air and Al-air semi-fuel cells which do not require storage of oxygen. Still, a hydrogen based fuel cell requires significant mass of storage containers for high pressure containment of H₂, or containment of H₂ in a metal or alloy, such as Pd, and other transition metal alloys, which have high molecular mass and generally must be heated to release H₂ from the alloy to insure high rate capability. By replacing H₂ as the anode reactant with a metal such as Zn and Al, high pressure containment of the anode reactant is eliminated, but still the mass of the anode in combination with their low cell potentials does not result in an extremely high energy density battery system. Abraham et al. (U.S. Pat. No. 5,510,209 and in Electrochemical Society, 1996) demonstrated, that a lithium-air battery based on a non-aqueous polymer electrolyte, which due to the low equivalent mass of Li (6.941 g/equivalent) and high potential of the lithium anode of slightly greater than 3V vs. the Standard Hydrogen Electrode, is the basis of a very high energy density battery. A non-aqueous based polymer electrolyte was required since water solubility in the electrolyte will exothermically react with metallic lithium producing hydrogen gas resulting in a parasitic reaction significantly reducing energy density capabilities as well as introducing a major safety problem. Water ingress into the system is based on the fact that the solubility of water in organic based polymer electrolytes or liquid based non-aqueous electrolyte solutions, while small in some cases, cannot be eliminated (e.g. see Read et al. and Satoh and Kuboki et al.). Another important factor limiting the specific capacity of these lithium-air, polymer and organic based electrolyte solutions containing a lithium salt is due to the fact that the product of the cell reaction is Li₂O and/or Li₂O₂, which precipitate at the surface and into the interior of the cathode and are electronic insulators, resulting in a complete shut down of the cell and battery. In the lithium-air cell and battery, the cathode is a high porosity and high surface area O₂-active carbon with and without addition of a catalyst, and can be fabricated by methods known to those practitioners active in the area of lithium, lithium-ion and fuel cells.

Because of the use of a non-aqueous electrolyte solution containing a lithium salt, the overall cell reactions of this type of lithium-air cell are:
2Li+½O₂→Li₂O↓ Mechanism 1:
2Li+O₂→Li₂O₂↓ Mechanism 2:
The downward arrow ↓ represents an insoluble product which precipitates in the porous carbon based air electrode which, when fully incorporated into said cathode structure, completely shuts down further cell or battery operation independent of how much metallic lithium is used in the anode. On the other hand, if the reaction products are soluble, the capacity and life time of the cell or battery is essentially indefinite depending upon the amount of lithium used in the anode, reaction mechanism and effect of pH as discussed below. The present invention demonstrates that replacing the nonaqueous catholyte solution (organic, polymer or ionic liquid) with an aqueous electrolyte solution significantly improves available specific capacity due to the elimination of precipitation of reaction products, and an increase in energy and power density due to increased cell potentials, long life operation times, and higher electrolyte solution conductivities. By placing the fuel-cell cathode in an aqueous acid solution, such as H₂SO₄ or H₃PO₄ and the like, the overall cell reaction is (aqueous sulfuric acid is used for this example):
2Li+½O₂+H₂SO₄ [symbol] Li₂SO₄+H₂O Mechanism 3:
Because Mechanism 3 involves H₂SO₄ as a reactant, the theoretical energy and capacity of this cell are less than those for mechanisms 1 and 2 for which the reaction products are solid Li₂O₂ and/or Li₂O (see Table 1). Still, the use of H₂SO₄ or H₃PO₄ has an important feature in that it can operate over the very large temperature range of −70° C. to over 150° C. as discussed below. In neutral or alkaline aqueous solutions, e.g. LiCl or LiOH and KOH aqueous solutions, the overall reaction for the aqueous lithium-air cell is
2Li+½O₂+H₂O [symbol] 2LiOH Mechanism 4:

where the reaction product LiOH is highly soluble in aqueous solutions. Note that in mechanisms 3 and 4, the symbol is used to indicate that this reaction is reversible, i.e. unlike mechanism 1 and 2 which involve precipitation of non-conductive insulator products Li₂O and Li₂O₂ in nonaqueous solutions into the porous cathode structure, the products of mechanisms 3 and 4 are Li₂SO₄ or LiOH, both of which are highly soluble in aqueous solution. The significance of this is that by placing the air cathode in an aqueous solution, the cell reaction products are soluble and are thereby rechargeable. Organic electrolyte based lithium-air cells which result in electronic insulating products, such as Li₂O and Li₂O₂ are not able to be recharged for extended cycles as is the lithium-air cell of the present invention, based on an aqueous electrolyte solution. Table 1 summarizes the theoretical specific energies and specific capacities of various metal-air cells, and data for a commercial lithium-ion cell are given for comparison.

TABLE 1
Theoretical Specific Energy and Capacity
Comparisons for Selected Metal Systems

| Metal-Air and Li-Ion Systems | | Specific | Specific |
|---|---|---|---|
| (aprotic organic or | OCV | Energy | Capacity |
| aqueous electrolyte sln) | (V) | (Wh/kg) | (mAh/g) |
| 2Li + ½O₂ → Li₂O | 2.913 | 11,248* | 3,862 |
| (aprotic organic sln) | | | |
| (mechanism 1) | | | |
| Li + ½O₂ → ½Li₂O₂ | 2.959 | 11,425* | 3,862 |
| (aprotic organic) | | | |
| (mechanism 2) | | | |
| 2Li + ½O₂ + H₂SO₄ ⇄ | 4.274 | 1,091* | 255 |
| Li₂SO₄ + H₂O | | | |
| (mechanism 3) | | | |
| 2Li + ½O₂ + H₂O ⇄ | 3.445 | 5789* | 1,681 |
| 2LiOH (mechanism 4) | | | |
| Al + 0.75O₂ + 1.5H₂O → | 2.701 | 4,021* | 1489 |
| Al(OH)₃ (aq) | | | |
| Zn + ½O₂ → ZnO | 1.650 | 1,353* | 820 |
| (aqueous) | | | |
| x6C + LiCoO₂ ⇄ xLiC₆ + | ˜4.2 | 420** | 100 |
| Li₁₋ₓCoO₂ | | | |
| (aprotic organic). | | | |

*The molecular mass of O₂ is not included in these calculations because O₂ is freely available from the atmosphere and therefore does not have to be stored in the battery or cell.
**Based on x = 0.5 in Li₁₋ₓCoO₂.

### SUMMARY OF THE INVENTION

Now it has been found, that the irreversibility of metal-air cells can be overcome, and the cell energy increased by adding an aqueous acid, base or neutral to the carbon/air cathode. The present invention relates to a high energy Li-air cell which is capable of long time operation over a wide range of temperature, e.g. −40° C. to over 100° C. The cell is based on a lithium metal anode protected from exposure to aqueous solutions, and a fuel cell based cathode which is immersed in an aqueous electrolyte solution. The cells have a high practical specific energies and high capacities. In sulfuric acid solution at 0° C. and 25° C, the open circuit voltage is 3.35 V. At a current density of 0.1 mA/cm², the operating potential of this cell is 2.9 V at 0° C. and 3.3 V at 25° C. In aqueous KOH solution, the observed OCVs for both 0° C. and 25° C. are 3.27 V, and for discharge at 0.1 mA/cm², the operating voltage is 3.20 V at both temperatures. Since the reaction products LiX (where X is the anion of the acid, e.g. sulfate, phosphate, chloride) or LiOH, (mechanisms 3 and 4) of the lithium-air cell of this invention do not precipitate, rechargeability represents another unique characteristic of this invention. Although water has a freezing point of 0° C. and a boiling point of 100° C., the cell is capable of operating over a wide range of temperatures by proper selection of the concentration of acid or base in the aqueous electrolyte solutions. For example, in aqueous acid solution, a 39.1 mass % sulfuric acid solution has a freezing point of −70° C. and specific conductivities of around 1.5 S/cm at 25° C. and 0.1 S/cm at −40° C. (Handbook of Batteries). Phosphoric acid is used for high temperature fuel cells (Fuel Cell Handbook) and for the present invention can be used for high temperature operation, up to at least 150° C. for an 85 mass % H₃PO₄ aqueous solution. While high temperature operation of a cell with metallic Li is limited by the melting point of Li, 180.5° C., temperatures up to 205° C. are possible using 100% H₃PO₄ and replacing metallic Li with a high melting point anode such as Be, Mg, Ca, Al, Zn and the like, all of which have melting points above 400° C. In aqueous alkaline solutions such as KOH, temperatures as low as −50° C. can be realized; e.g. a 28 mass % KOH solution has a freezing point of −49° C. and a freezing point of −20° C. for an 18 mass % KOH solution (OxyChem Caustic Potash Handbook). The use of either aqueous acid or alkaline solutions for a practical Li-air cell can be based on specific applications relating to required energies, capacities, range of temperature operation, and lifetime under continuous discharge.

The principal object of this invention is to provide a higher energy density metal-air cells over the prior art.

Another object of this invention is to provide rechargeable metal-air electrochemical cell. Other objects and advantages of the invention will be apparent from the description and claims.

### BRIEF DESCRIPTION OF THE DRAWINGS

FIG. 1 is a sectional schematic view, illustrating the aqueous acid-based lithium-air cell showing the lithium anode protected from the aqueous acid solution by two membranes, the first constituting a porous electrospun or polyolefin membrane saturated with an organic electrolyte solution, and the second membrane is a solid-state lithium ion conducting glass or glass ceramic, which is impermeable towards water.

FIG. 2 shows the discharge voltage of as a function of time, in and aqueous KOH solution at 0° C., of a lithium-air cell of this invention. A portion of the charging curve is also shown in FIG. 2.

FIG. 3 shows the discharge voltage as a function of time, in aqueous H₂SO₄ solution at 25° C., of a lithium-air cell of this invention.

FIG. 4 shows the discharge voltage as a function of time, in aqueous H₂SO₄ solution at 0° C., of a lithium-air cell of this invention.

FIG. 5 shows the discharge voltage as a function of time, in aqueous H₂SO₄ solution at 25° C., of lithium-air cell of this invention, and a section of the first cycle recharge.

FIG. 6 shows the discharge voltage as a function of time at 25° C. of lithium-water cells of this invention, comparing the use of an electrospun membrane to a commercial microporous polyolefin membrane.

It should, of course, be understood that the description and the drawings herein are merely illustrative, and it will be apparent that various modifications, combinations and changes can be made of the structures and the systems disclosed without departing from the spirit of the invention and from the scope of the appended claims.

### DESCRIPTION OF THE PREFERRED EMBODIMENTS

When referring to the preferred embodiments, certain terminology will be utilized for the sake of clarity. Use of such terminology is intended to encompass not only the described embodiment, but also all technical equivalents which operate and function in substantially the same way to bring about the same results.

Metal-air based electrochemical devices, and for example primary lithium-air cells, usually comprise a lithium foil anode (−) layer, and a porous carbon cathode (+) layer having a nonaqueous liquid or polymeric lithium-ion conducting layer sandwiched therebetween. Oxygen in the air enters the porous carbon layer and results in an open circuit potential slightly less that 3 volts potential against lithium. Present invention employs a novel rechargeable cell structure, which also provides a higher voltage and thus higher energy density.

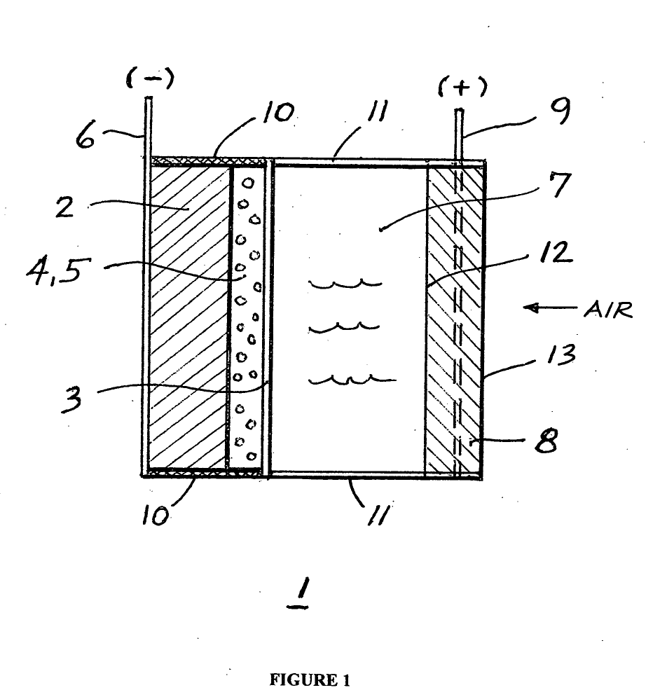

Referring now in more detail to the drawings of this patent, one embodiment of this invention can be understood by reference to FIG. 1. The cell 1 comprises: lithium anode 2; at least one outer water-impervious, lithium-ion conducting solid-state glass-ceramic layer 3 with at least one porous inert membrane 4 saturated with a lithium compatible and lithium-ion conductive electrolyte solution 5; a solid metal current collector 6; aqueous acid electrolyte solution 7; and a porous carbon-based cathode 8, coated on a porous metal current collector 9.

The anode 2 is in contact with the collector 6 and the membrane 4, which is in contact with the glass-ceramic layer 3. The aqueous acidic, neutral or alkaline solution 7 is between and in contact with the glass-ceramic layer 3 and the cathode 8.

The membrane 4 is required when the outer glass-ceramic layer 3 is reactive with metallic lithium. The outer solid-state lithium-ion conducting glass-ceramic layer 3 is impermeable to water, which is required, since the cathode 8 of this invention is in contact with the aqueous electrolyte solution 7, and is accessible to air. The preferred outer solid-state glass-ceramic layer is a product of Ohara Corp. (U.S. Pat. No. 6,485,622). but other solid-state lithium-ion conducting membranes which are stable when in contact with aqueous solutions can also be used.

The lithium anode 2 and the membrane 4 are hermetically sealed all around with epoxy frame 10, which is also hermetically joined to the glass-ceramic layer 3.

Similarly, the aqueous electrolyte solution 7 is enclosed by frame 11, which is sealed to the separator 3 and to the cathode 8. The frame 11 may have a filling port (not shown), and the cathode 8 may be covered by a well known removable sealing tape (not shown) to prevent evaporation of the aqueous electrolyte 7. This sealing tape is removed when the cell 1 is connected to an electric load, which tape removal permits the air/oxygen to enter the porous carbon cathode and thus activate the cell. The cathode 8 has inner surface 12 and outer surface 13.

The membrane 4 in contact with lithium anode 2 is a porous inert membrane containing a lithium compatible lithium-ion conductive electrolyte solution 5. The inert membrane comprises a commercial micro porous polyolefin, such as Celgard 2300 or 2500 and the like, which have porosities of 42% or less, or preferably a membrane produced by electrospinning, which has a porosity of 80% or greater (Meyer et al.). The membrane 4 is saturated with a lithium-ion conductive nonaqueous electrolyte solution 5, such as a pure or mixed polar organic solvent with a lithium salt, as the electrolyte. Examples of organic-based solvents stable towards metal lithium are propylene carbonate, dimethyl carbonate, diethyl carbonate, ethylene carbonate, ethylmethyl carbonate, dimethoxy methane, 1-butyl-1-methylpyrrolidinium imide, and the like. Examples of the dissolved electrolyte are lithium salts such as LiAF₆, LiPF₆, LiBF₄, LiC10₄, LiSO₃CF₃, LiN(SO₂CF₃)₂, LiN(SO₂C₂F₅)₂, Li[(C₂O₄)₂B] and the like. These and other lithium stable electrolyte solutions are well known to practitioners of lithium and lithium-ion battery technology. The preferred inert membrane used to contain the lithium-ion conductive electrolyte solution is prepared by electrospinning and is comprised of a polyimide such as Matrimid®, and Ultem®, PVDF (poly(vinylidene fluoride)), PAN (polyacrylonitrile), or blends and copolymers of polyimide, PVDF and PAN.

The second and outermost membrane 3 in contact with the inert polyolefin or electrospun membrane 4 is a water impervious lithium-ion conducting glass-ceramic, such as Ohara Corporation's LIC-GC material comprised of various oxides of P, Si, Ge, Ti, Zn, Al, Ga, an lanthanide and Li (U.S. Pat. No. 6,485,622 and earlier cited patents, which are herein incorporated by reference). Other lithium-ion conducting glass-ceramics, such as Lipon and Lisicon may by used, but their stability towards aqueous solutions has not been fully established, and the Ohara Corporation's LIC-GC material is selected for the preferred embodiment.

The anode is of a composite design, which can be placed in a water impervious housing, such as made of stainless steel or nickel using an o-ring design or epoxy frame to completely seal the composite anode from the aqueous solutions. Both the o-ring and epoxy methods of sealing the composite anode are equally acceptable.

The cathode 8 of this invention is a fuel cell type electrode comprised of a high surface area carbon known to be electro active for the reduction of O₂, and with or without small (10% or preferably less) additions of a second metal catalyst such as Pt, Pd, Ru, Mn, Ag, and the like. One embodiment of an acceptable cathode for this invention which is easily fabricated by practitioners in the fields of lithium, lithium-ion and fuel cells is based on a high surface area carbon such as Super P, Black Pearls 2000, Vulcan-XC-72, Shawinigan black, and the like, and a binder such as polytetrafluoroethylene Teflon, or PVDF, or polyimide, or their blends and copolymers. Typical compositions of this cathode comprise around 90 mass % carbon and 10% binder (Read et al.). Also acceptable for a cathode electrode is a commercial product such as Alupower's air/O₂ fuel cell electrode with small additions Ag or Mn catalyst (e.g. U.S. Pat. No. 5,053,375) or E-TEK's “LT 120E-W” air/oxygen fuel cell electrode which contains small additions of Pt catalyst. The preferred embodiment of this invention is the incorporation of a commercial fuel cell electrode for the following reasons: The inner surface 12 of the cathode electrode facing (immersed in) the aqueous acid solution must be highly catalytic for the electrochemical reduction of O₂, and the outer surface 13 should preferably contain a hydrophobic material such as Teflon to prevent the aqueous acidic, neutral or alkaline solution from absorbing into this outer surface layer which will retard access (solubility and diffusion) of atmospheric O₂ into the bulk (innermost) layer of the electrode where the electrochemical reduction of O₂ occurs. Both the Alupower and E-TEK fuel cell type air/oxygen electrodes include a hydrophobic outermost layer of Teflon to optimize O₂ access into the bulk of the electrode structure.

The preferred embodiment of the cathode involves its immersion in an acidic, neutral or alkaline aqueous electrolyte solution, which is highly conductive over a large temperature range. The inner surface 12 of the cathode 8 faces the acidic electrolyte solution 7 and the outer surface 13 faces the atmosphere to permit O₂ access to the electrode. In order to realize the full potential of this invention it is essential that the inner surface of the cathode faces an aqueous electrolyte solution (mechanisms 3 and 4). In acid solutions, almost any acid dissolved in water will meet this requirement, e.g. HCl, HClO₄, organic acids, such as acetic acid and the like, H₂SO₄ and H₃PO₄, and their mixtures. The preferred acids for this invention are H₂SO₄ and H₃PO₄. For operation of the acid-based lithium-air cell/battery of this invention between temperatures of −40° C. and 100° C., H₂SO₄ is preferred acid to be used. For operation of the lithium-air cellbattery of this invention above 100° C. but not exceeding 158° C., either H₂SO₄ or H₃PO₄ can be used, but the preferred aqueous electrolyte over this temperature range is H₂SO₄ in the composition range of 30 to 40 mass %. In this composition range, aqueous H₂SO₄ solutions have freezing points between −52° C. and −70° C. and very high conductivities ranging from 0.8 to 1.5 S/cm (Handbook of Batteries). For higher temperature applications, particularly where the melting point of lithium (180.5° C.) is exceeded, the present invention is applicable simply by replacing the lithium anode with a high melting point metal (e.g. Be, Mg, Ca, Al, Zn, Ba, Sr, and their alloys), and using 100% H₃PO₄ as the electrolyte solution which can operate up to a temperature of around 205° C. (Handbook of Fuel Cells).

For temperatures below 180 C, other metals can be used, such as Na,K,Rb,Cs, and their alloys.

In neutral or alkaline based electrolyte solutions, almost any salt (e.g. LiCl, LiClO4, Li2SO4, NaCl, and their mixtures) or alkali metal hydroxide (e.g. LiOH, KOH, NaOH, CsOH, and their mixtures) can be used. The concentrations of these salts and hydroxides can be varied to optimize conductivity and freezing points of the aqueous solution. For operation between −40° C. and 100° C., the preferred hydroxide is KOH, and composition of this aqueous electrolyte solution can be anywhere between 15 mass % KOH and 28 mass % for which the freezing points are, respectively, −15° C. and −50° C. (OxyChem Caustic Potash Handbook). The electrolytic conductivities of these solutions at 20° C. are 0.45 S/cm for a 15 mass % KOH solution and 0.62 S/cm for a 28 mass % KOH solution.

By placing the air cathode in contact with an aqueous solution, the cell reaction products are soluble and are thereby rechargeable (reversible), thus resulting in rechargeable cells. The following examples illustrate the advances of a lithium-air aqueous-acid, aqueous base, neutral, and seawater based cells/batteries.

### EXAMPLE #1

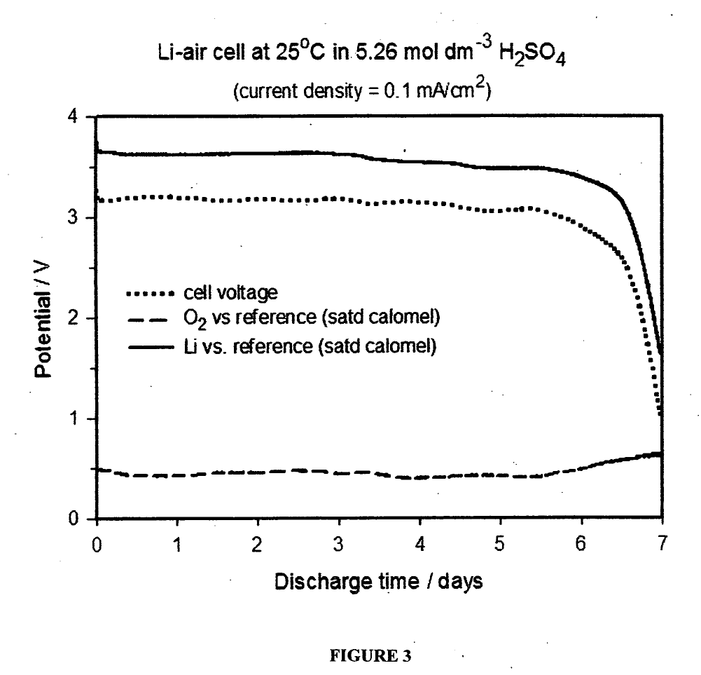

A lithium-air cell (No. 1 corresponding to Mechanism 3) was prepared according to the schematic of FIG. 1, in which the first membrane in contact with lithium is a Celgard 2300 micro-porous inert membrane containing a lithium compatible lithium ion conductive electrolyte solution comprised of a 1 mol/dm³ LiPF₆ in a 1:3 mixture (w/w) of EC:EMC (ethylene carbonate and ethylmethyl carbonate). The thickness of this first membrane in contact with metallic lithium is 25 μm. The outer membrane is Ohara's glass-ceramic LIC-GC material, which is 75 μm thick, and the edges of this composite anode are sealed with an epoxy (Epon 828/3234) to completely eliminate the ingress of water into the composite anode electrode. This composite anode was immersed in an aqueous H₂SO₄ solution containing 39.1 mass % H₂SO₄ which corresponds to a concentration of 5.26 mol dm³. The freezing point of this aqueous acid solution is −70° C., and its conductivities at 25° C. and −40° C. are around 1.5 S/cm and 0.8 S/cm, respectively. The cathode is an Alupower carbon/air electrode with Mn added as a catalyst as described in the U.S. Pat. No. 5,053,375. The cell was discharged at 0.1 mA/cm2, based on the lithium surface area at 25° C., as shown in FIG. 3, which is another embodiment of the invention. The end of life was recorded after almost 8 days of constant current discharge to a cut off voltage of 1V versus the reference electrode (saturated calomel). The average discharge cell potential was 3.25V, well above the potential of around 2.7 to 2.8V at 0.1 mA/cm² observed in organic electrolyte-based electrolyte solutions (Abraham et. al., Read et al., Dobley et al., and Satoh and Kuboki et al.) The cell delivered 5.3 mAh/g based on lithium which eventually failed (ended) due to the depletion of lithium. It is noted that the potential of the air electrode versus the reference electrode remained constant during this experiment, confirming that no precipitation of reaction products had occurred.

### EXAMPLE #2

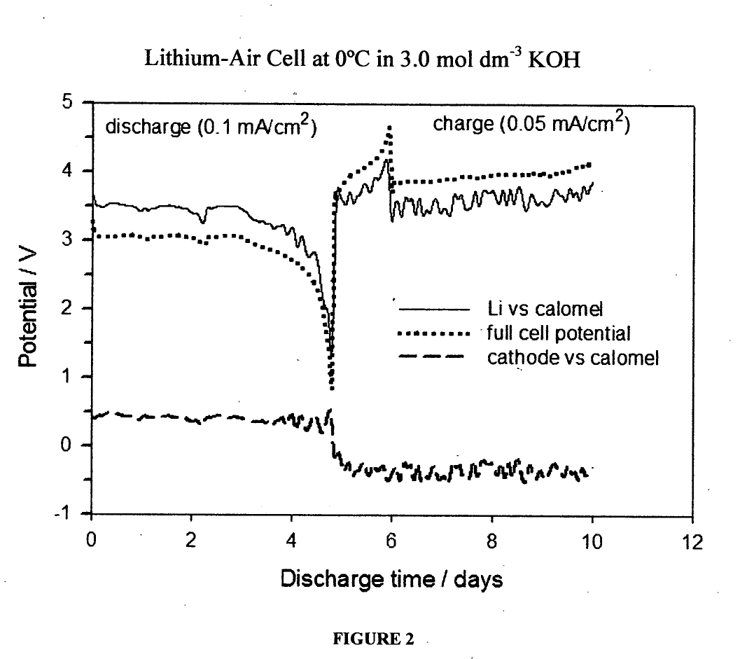

A lithium-air cell (No. 2 corresponding to Mechanism 4) was prepared according to the schematic of FIG. 1 in which the first membrane in contact with lithium is a Celgard 2325 microporous inert membrane containing a lithium compatible, lithium ion conductive electrolyte solution comprised of a 1 mol/dm³ LiPF6 in a 1:3 mixture (w/w) of EC:EMC (ethylene carbonate and ethylmethyl carbonate). The thickness of this first membrane in contact with metallic lithium is 25 μm. The outer water stable membrane is Ohara's glass-ceramic LIC-GC material which is 75 μm thick, and the edges of this composite anode were sealed with an epoxy (Epon 828/3234) to completely eliminate the ingress of water into the composite anode electrode assembly. This composite anode was immersed in an aqueous KOH solution containing 15 mass % KOH which corresponds to a concentration of 3 mol dm³. The freezing point of this aqueous alkaline solution is −15° C., and its conductivity at 20° C. is around 0.46 S/cm. The cathode used was an Alupower carbon/air electrode with Mn added as a catalyst as described U.S. Pat. No. 5,053,375. The cell was discharged 0.1 mA/cm² based on the lithium surface area at 0° C. and 25° C. The first 4.5 days of discharge at 0° C. is shown in FIG. 2 along with a portion of the first cycle charging curve, which is another embodiment of the invention. As shown in this figure, the average discharge potential of the cell is 3.20V.

### EXAMPLE #3

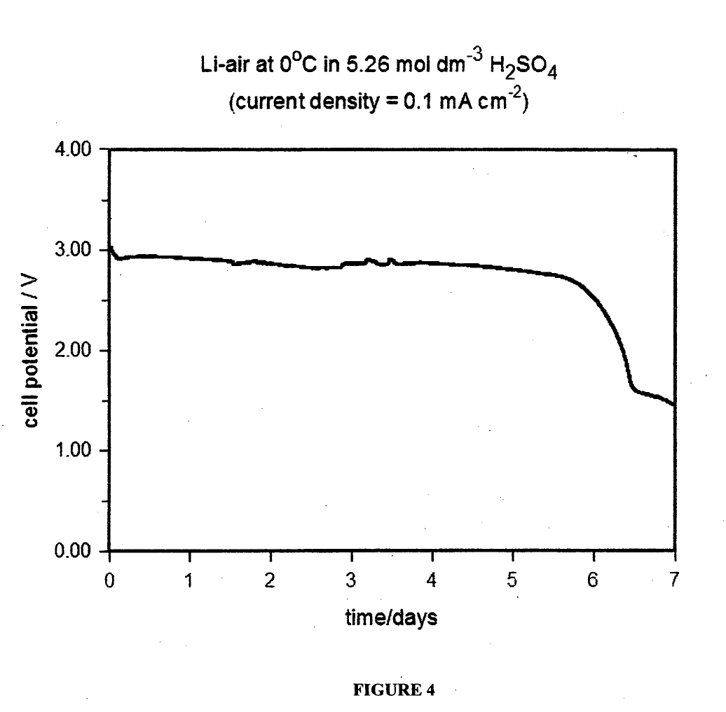

A lithium-air cell (No. 3) was prepared in an identical manner as the cell described in Example 1. However, as shown in FIG. 4, which is another embodiment of this invention, it was discharged at 0° C. at a constant current of 0.1 mA/cm² until almost all of the lithium in the anode was depleted (again, a capacity of 5.3 mAh/g lithium was achieved). A reference electrode was not used in this study.

### EXAMPLE #4

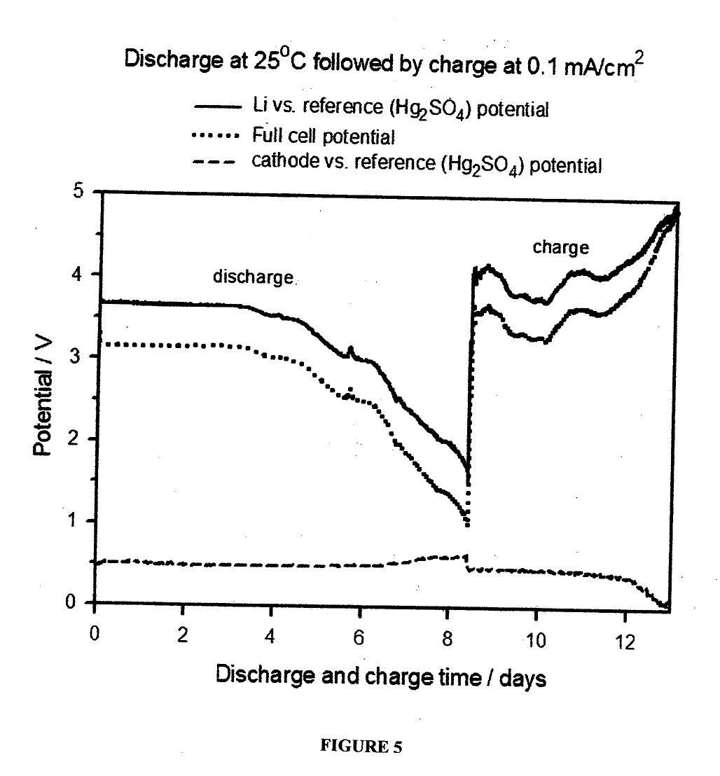

A lithium-air cell (No. 4) was prepared in an identical manner as the cell described in Example 1 and discharged at 0.1 mA/cm² at 25° C. The reference electrode used in this example was Hg₂SO₄, and as in example 1, the cell discharged for 8.4 days at an average potential of 3.25V and delivered a capacity 6.4 mAh/g lithium, before the lithium was exhausted, as shown in FIG. 5, which is another embodiment of the invention. FIG. 5 also shows the partial voltage versus time characteristics of this cell when charged to a cut off cell voltage of 5V.

### EXAMPLES #5 & #6

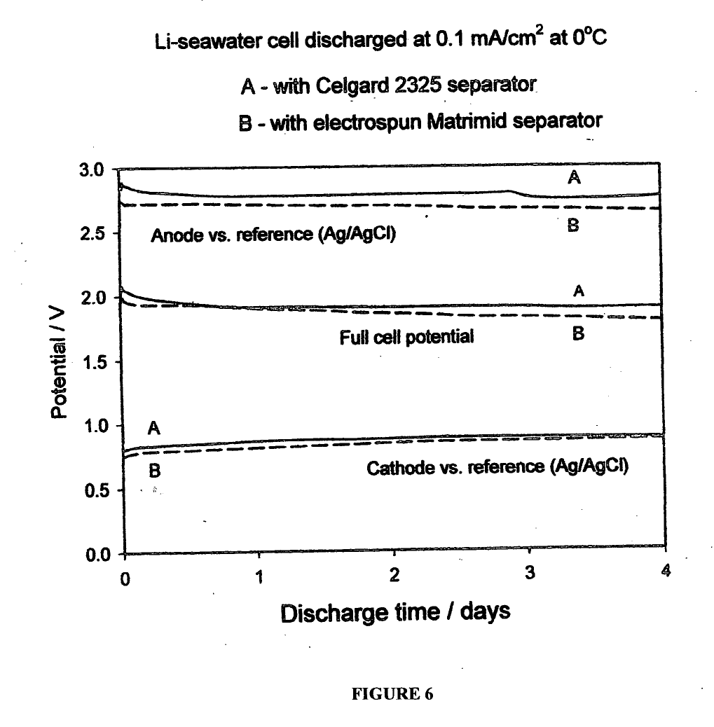

Lithium-seawater cells (Nos. 5 and 6) were prepared in an identical manner as the cell described in Example 1 and discharged at 0.1 mA/cm² at 25° C. However, the electrolyte solution used in this experiment is synthetic seawater (ASTM Designation D 1141-98), and because O₂ is not a reactant in this lithium-seawater cell, the overall cell reaction is Li+H₂O→LiOH+½H₂. Because artificial seawater was used as the electrolyte solution in this experiment, the reference electrode used is Ag/AgCl, as shown in FIG. 6, which is another embodiment of the invention. The cells are based on the composite protected lithium anode, but have a solid platinum cathode, and are discharged at a current density of 0.1 mA/cm² at 0° C. at an average cell potential of 1.9V. For the cell No. 5, the first membrane in contact with lithium is a Celgard 2300 micro porous inert membrane containing a lithium compatible, lithium-ion conductive electrolyte solution comprised of a 1 mol/dm³ LiBF₄ in a 1:3 mixture (w/w) of EC:EMC (ethylene carbonate and ethylmethyl carbonate), and for the cell No. 6, the first membrane in contact with lithium is an electrospun Matrimid porous inert membrane containing a lithium compatible lithium-ion conductive electrolyte solution comprised of a 1 mol/dm³ LiBF4 in a 1:3 mixture (w/w) of EC:EMC (ethylene carbonate and ethylmethyl carbonate). The thickness of both membranes is 25 μm. The outer membrane in both cells 5 and 6 is Ohara's glass-ceramic LIC-GC material which is 150 μm thick, and the edges of this composite anode was sealed with an epoxy (Epon 828/3234) to completely eliminate the ingress of water into the composite anode electrode.

It is apparent to a person skilled in the art, that the above described cells can be made in any size desired, and that many cells can be connected to create multicelled high voltage batteries. It should, of course be understood that the description and the drawings herein are merely illustrative and it will be apparent that various modifications, combinations and changes can be made of the structures and the systems disclosed without departing from the spirit of the invention and from the scope of the appended claims.

It will thus be seen that novel and improved cells' structures have been provided with which the objects of the invention are achieved.

We claim:

1. A metal-air semi-fuel cell comprising:
A fuel cell type air/oxygen cathode, which includes inner surface and outer surface, and which is stable towards aqueous acid electrolyte solutions;
an electroactive metal anode with at least one electrolyte layer which layer is separating said anode and said cathode, and in which layer at least one layer is a cation conducting solid glass-ceramic impervious to and stable towards aqueous acid electrolyte solutions; and
an aqueous acid electrolyte solution in contact with said solid glass-ceramic layer and with said cathode inner surface.

2. A metal-air semi-fuel cell comprising:
A fuel cell type air/oxygen cathode, which includes inner and outer surface, and which is stable towards aqueous base electrolyte solutions;
an electroactive metal anode with at least one electrolyte layer which layer is separating said anode and said cathode, and in which layer at least one layer is a cation conducting solid glass-ceramic impervious to and stable towards aqueous base electrolyte solutions; and
an aqueous base electrolyte solution in contact with said solid glass-ceramic layer and with said cathode inner surface.

3. A metal-air semi-fuel cell comprising:
A fuel cell type air/oxygen cathode, which includes inner surface and outer surface, and which is stable towards an aqueous neutral electrolyte solution;
an electroactive metal anode with at least one electrolytic layer which layer is separating said anode and said cathode, and in which layer at least one layer is of cation conducting solid glass-ceramic imperious to and stable towards aqueous neutral electrolyte solutions; and
an aqueous neutral electrolyte solution in contact with said solid glass-ceramic layer and with said cathode inner surface.

4. A semi-fuel cell as described in claim 1, or 2, or 3, in which said metal anode is selected from the group of metals comprising lithium, and lithium alloys with aluminum, silicon, tin and magnesium.

5. A semi-fuel cell as described in claim 1, or 2, or 3, in which said metal anode is selected from the group of metals comprising Na, K, Rb, Cs, Be, Mg, Ca, Sr, Ba, Al, Zn, and their alloys.

6. A semi-fuel cell as described in claim 1, in which said electro active metal anode is protected from said aqueous electrolyte solution by at least one additional layer comprising an inert porous membrane in contact with said metal anode, and which membrane is saturated with an ionically conductive non-aqueous liquid electrolyte solution, which solution is stable towards said metal anode.

7. A semi-fuel cell as described in claim 6, in which said porous membrane is electrospun and is made of polymers selected from the group comprising a polyimide, polyvinylidene fluoride, polyacrylonitrile, and their blends and copolymers.

8. A semi-fuel cell as described in claim 6, in which said porous membrane is a microporous polyolefin membrane.

9. A semi-fuel cell as described in claim 6, in which said non-aqueous electrolyte comprises an organic-based solvent which is stable towards said metal; and a metal salt.

10. A semi-fuel cell as described in claim 6, in which said nonaqueous electrolyte comprises a polar organic-based solvent selected from the group consisting of propylene carbonate, dimethyl carbonate, diethyl carbonate, ethylene carbonate, ethylmethyl carbonate, dimethoxy methane, 1 -butyl-1-methylpyrrolidinium imide and their mixtures; and a metal salt.

11. A semi-fuel cell as described in claim 6, in which said non-aqueous electrolyte comprises a polar organic-based solvent and a lithium salt selected from the group consisting of LiAsF₆, LiPF₆, LiBF₄, LiClO₄, LiSO₃CF₃, LiN(SO₂CF₃)₂, LiN(SO₂C₂F₅)₂, Li[(C₂O₄)₂B], and their mixtures.

12. A semi-fuel cell as described in claim 2, in which said electro active metal anode is protected from said aqueous electrolyte solution by at least one additional layer comprising an inert porous membrane in contact with said metal anode, and which membrane is saturated with an ionically conductive non-aqueous liquid electrolyte solution, which solution is stable towards said metal anode.

13. A semi-fuel cell as described in claim 12, in which said porous membrane is electrospun and is made of polymers selected from the group comprising polyimide, polyvinylidene fluoride, polyacrylonitrile and their blends and copolymers.

14. A semi-fuel cell as described in claim 12, in which said porous membrane is a microporous polyolefin membrane.

15. A semi-fuel cell as described in claim 12, in which said non-aqueous electrolyte comprises an organic solvent which is stable towards said metal; and a metal salt.

16. A semi-fuel cell as described in claim 12, in which said nonaqueous electrolyte comprises an organic solvent selected from the group consisting of propylene carbonate, dimethyl carbonate, diethyl carbonate, ethylene carbonate, ethylmethyl carbonate, dimethoxy methane, 1-butyl-1-methylpyrrolidinium imide and their mixtures; and a metal salt.

17. A semi-fuel cell as described in claim 12, in which said non-aqueous electrolyte comprises a polar organic solvent, and a lithium salt selected from the group consisting of LiAsF₆, LiPF₆, LiBF₄, LiClO₄, LiSO₃CF₃, LiN(SO₂CF₃)₂, LiN(SO₂C₂F₅)₂, Li[(C₂O₄)₂B], and their mixtures.

18. A semi-fuel cell as described in claim 3, in which said active electro metal anode is protected from said aqueous electrolyte solution by at least one additional layer comprising an inert porous membrane in contact with said metal anode, and which membrane is saturated with an ionically conductive non-aqueous liquid electrolyte solution, which solution is stable towards said metal anode.

19. A semi-fuel cell as described in claim 18, in which said porous membrane is electrospun and is made of polymers selected from the group comprising a polyimide, polyvinylidene fluoride, polyacrylonitrile, and their blends and copolymers.

20. A semi-fuel cell as described in claim 18, in which said porous membrane is a microporous polyolefin membrane.

21. A semi-fuel cell as described in claim 18, in which said nonaqueous electrolyte comprises an organic solvent which is stable towards said metal; and a metal salt.

22. A semi-fuel cell as described in claim 18, in which said nonaqueous electrolyte comprises an organic-based solvent selected from the group consisting of propylene carbonate, dimethyl carbonate, diethyl carbonate, ethylene carbonate, ethylmethyl carbonate, dimethoxy methane, 1-butyl-1-methylpyrrolidinium imide and their mixtures; and a metal salt.

23. A semi-fuel cell as described in claim 18, in which said nonaqueous electrolyte comprises an organic solvent and a lithium salt selected from the group consisting of LiAsF₆, LiPF₆, LiBF₄, LiClO₄, LiSO₃CF₃, LiN(SO₂CF₃)₂, LiN(SO₂C₂F₅)₂, Li[(C₂O₄)₂B], and their mixtures.

24. A semi-fuel cell as described in claim 1, in which said acid is H₂SO₄, H₃PO₄, HCl, and their mixtures.

25. A semi-fuel cell as described in claim 2, in which said base is KOH, LiOH, NaOH, CsOH, and their mixtures.

26. A semi-fuel cell as described in claim 3, in which said neutral is LiCl, LiCPO₄, Li₂SO₄, NaCl, and their mixtures.

27. A semi-fuel cell as described in claim 1, or 2, or 3, in which said solid glass-ceramic layer is un-reactive with organic electrolyte solutions and also is un-reactive with aqueous electrolyte solutions.

28. A semi-fuel cell as described in claim 1, or 2, or 3, in which said solid glass-ceramic layer is made of lithium ion conducting, solid-state glass-ceramic material.

29. A semi-fuel cell as described in claim 1, or 2, or 3, which is rechargeable.
